(19) United States
(12) Patent Application Publication
(10) Pub. No.: US 2019/0139701 A1
(43) Pub. Date: May 9, 2019

(54) ARRAY WIRELESS ENERGY CONVERSION DEVICE AND DESIGN METHOD THEREOF

(71) Applicant: Chih-Chuan Liang, Hsinchu City (TW)

(72) Inventor: Chih-Chuan Liang, Hsinchu City (TW)

(21) Appl. No.: 16/304,306

(22) PCT Filed: May 25, 2017
(86) PCT No.: PCT/CN2017/085994

§ 371 Date: Nov. 26, 2018

Related U.S. Application Data
(60) Provisional application No. 62/342,163, filed on May 26, 2016.

(51) Int. Cl. H01F 38/14; H02J 7/02; H02J 50/10; H01F 27/29

(52) U.S. Cl. CPC H01F 38/14; H01F 27/29; H02J 50/10; H02J 7/025

(57) ABSTRACT

An array wireless energy conversion device includes a first patterned conductive layer and a conductive structure. The first patterned conductive layer includes coil units with different geometric centers, where each coil unit is a polygon, at least one side of each coil unit is adjacent to one side of another coil unit, and each coil unit has a fracture and two corresponding first ends. The conductive structure is disposed under the first patterned conductive layer and connected to the first ends. The conductive structure has a pair of input electrodes, the input electrodes connect to an external current, so that the current sequentially passes through the coil units to form a magnetic field in each coil unit. The current passes through each coil unit in a clockwise direction or an anticlockwise direction, such that the magnetic fields equivalently perpendicular to the first patterned conductive layer have a same polarity direction.

### BACKGROUND OF THE INVENTION

### Field of the Invention

The invention relates to an energy conversion device and a design method of the energy conversion device, and particularly relates to an array wireless energy conversion device and a design method thereof.

### Description of Related Art

Wireless charging technique may adopt an electromagnetic coupling principle to achieve a charging effect, by which electronic products may be charged by approaching to a wireless charging device without wiring, so as to improve usage convenience of the electronic products. Therefore, the wireless charging technique has become one of the major development technologies in the industry.

The existing wireless charging devices (such as wireless charging boards) mostly use a traditional coil configured under a charging plane to generate a charging magnetic field. In the conventional coil, multi-turn coil units with concentric circles are sequentially stacked in a direction perpendicular to the charging plane, and the stacking method cannot effectively ameliorate a magnetic line density of the original single-turn coil unit above the charging plane, such that a charged device has to be very close to the charging plane of the wireless charging device in order to be successfully charged.

### SUMMARY OF THE INVENTION

The invention is directed to an array wireless energy conversion device and a design method thereof, an effectively charging distance of a wireless charging device is increased by adjusting an arranging mode of basic coil units in an array.

The invention provides an array wireless energy conversion device including a first patterned conductive layer and a conductive structure. The first patterned conductive layer includes a plurality of coil units with different geometric centers, where each of the coil units is a polygon, at least one side of each of the coil units is adjacent to one side of another of the coil units, and each of the coil units has a fracture and two first ends corresponding to the fracture. The conductive structure is disposed under the first patterned conductive layer and is connected to the first ends, such that the coil units construct a continuous circuit through the conductive structure, where the conductive structure has a pair of input electrodes, the pair of input electrodes are adapted to connect an external current, so that the current sequentially passes through the coil units to form a magnetic field in each of the coil units, wherein the current passes through each of the coil units in a clockwise direction or an anticlockwise direction, such that the magnetic fields formed on the coil units and equivalently perpendicular to the first patterned conductive layer have a same polarity direction.

In an embodiment of the invention, the conductive structure includes a second patterned conductive layer and a plurality of first conductive vias, the first ends are respectively connected to the second patterned conductive layer through the first conductive vias, where the second patterned conductive layer includes the pair of input electrodes.

In an embodiment of the invention, the second patterned conductive layer includes a plurality of first conductive sections separated from each other, each of the first conductive sections has two second ends opposite to each other, and the second ends are respectively aligned with the first ends and are respectively connected to the first ends through the first conductive vias.

In an embodiment of the invention, the conductive structure includes a second patterned conductive layer, a plurality of first conductive vias, a third patterned conductive layer and a plurality of second conductive vias, a part of the first ends are respectively connected to a part of the second patterned conductive layer through a part of the first conductive vias, a part of the first ends are connected to a part of the third patterned conductive layer through a part of the first conductive vias, and a part of the third patterned conductive layer is connected to a part of the second patterned conductive layer through the second conductive vias, and the third patterned conductive layer includes the input electrodes.

In an embodiment of the invention, the second patterned conductive layer includes a plurality of first conductive sections separated from each other, each of the first conductive sections has two second ends opposite to each other, the third patterned conductive layer includes a plurality of second conductive sections separated from each other, each of the second conductive sections has two third ends opposite to each other, a part of the second ends are respectively aligned with a part of the first ends and are respectively connected to a part of the first ends through a part of the first conductive vias, a part of the second ends are respectively aligned with a part of the third ends and are respectively connected to a part of the third ends through the second conductive vias, a part of the third ends are respectively connected to a part of the second patterned conductive layer through the second conductive vias, and a part of the third ends are respectively connected to a part of the first patterned conductive layer through a part of the first conductive vias.

In an embodiment of the invention, the array wireless energy conversion device further includes a plurality of permeability magnetic materials, where the permeability magnetic materials are respectively configured in the coil units.

In an embodiment of the invention, each of the coil units has a geometric center and a radius, where the radius is the shortest distance between the geometric center and the side, and a distance between two of the geometric centers of two adjacent ones of the coil units is greater than twice of the radius and smaller than 5/2 of the radius.

In an embodiment of the invention, the geometric center of each of the coil units is located outside each of the other coil units.

The invention provides a design method of an array wireless energy conversion device, which includes following steps: determining a shape of a coil unit; determining an arranging mode of a plurality of coil units with different geometric centers according to the shape of the coil unit, such that at least one side of each of the coil units is adjacent to one side of another of the coil units, where the coil units construct a first patterned conductive layer; determining positions of a fracture and two corresponding first ends of each of the coil units according to the arranging mode of the coil units; and determining a distribution mode of a conductive structure according to the positions of the first ends, where the conductive structure is connected to the first ends, such that the coil units construct a continuous circuit through the conductive structure, where the conductive structure has a pair of input electrodes, the pair of input electrodes are adapted to connect an external current, so that the current sequentially passes through the coil units to form a magnetic field in each of the coil units, wherein the current passes through each of the coil units in a clockwise direction or an anticlockwise direction, such that the magnetic fields formed on the coil units and equivalently perpendicular to the first patterned conductive layer have a same polarity direction.

In an embodiment of the invention, the step of determining the distribution mode of the conductive structure includes: determining a distribution mode of a second patterned conductive layer and a plurality of first conductive vias according to the positions of the first ends, where the first ends are respectively connected to the second patterned conductive layer through the first conductive vias, and the second patterned conductive layer includes the input electrodes.

In an embodiment of the invention, the step of determining the distribution mode of the second patterned conductive layer includes: determining positions of a plurality of first conductive sections separated from each other according to the positions of the first ends, where each of the first conductive sections has two second ends opposite to each other, and the second ends are respectively aligned with the first ends, and are respectively connected to the first ends through the first conductive vias.

In an embodiment of the invention, the step of determining the distribution mode of the conductive structure includes: determining a distribution mode of a part of a second patterned conductive layer, a part of a third patterned conductive layer and a plurality of first conductive vias according to the positions of the first ends, where a part of the first ends are respectively connected to a part of the second patterned conductive layer through a part of the first conductive vias, and a part of the first ends are connected to a part of the third patterned conductive layer through a part of the first conductive vias; and determining a distribution mode of a part of the third patterned conductive layer and a plurality of second conductive vias according to the distribution mode of a part of the second patterned conductive layer, where a part of the third patterned conductive layer is connected to a part of the second patterned conductive layer through the second conductive vias, and the third patterned conductive layer includes the input electrodes.

In an embodiment of the invention, the step of determining the distribution mode of the second patterned conductive layer includes: determining positions of a plurality of first conductive sections separated from each other according to the positions of a part of the first ends and positions of the second conductive vias, where each of the first conductive sections has two second ends opposite to each other, and a part of the second ends are respectively aligned with a part of the first ends, and are respectively connected to a part of the first ends through a part of the first conductive vias, and a part of the second ends are respectively aligned with the second conductive vias to connect a part of the third patterned conductive layer. The step of determining the distribution mode of the third patterned conductive layer includes: determining positions of a plurality of second conductive sections separated from each other according to the distribution mode of a part of the second patterned conductive layer and the distribution mode of a part of the first patterned conductive layer, where each of the second conductive sections has two third ends opposite to each other, a part of the third ends are respectively connected to a part of the second patterned conductive layer through the second conductive vias, and a part of the third ends are connected to the first patterned conductive layer through a part of the first conductive vias.

According to the above description, in the array wireless energy conversion device of the invention, the coil units are distributed in a single-layer structure (the first patterned conductive layer) with different geometric centers, instead of the multi-turn coil units of the conventional coils sequentially stacked or distributed as single layer concentric circles. Therefore, through a proper arrangement and distribution of the coil units, the charging magnetic fields generated by the coil units are sufficiently superimposed in the direction perpendicular to the first patterned conductive layer to increase a distribution altitude of the charging magnetic fields. Further, by determining the arranging mode of the coil units according to the shape of the coil units, at least one side of each coil unit is adjacent to and parallel to one side of another coil unit, such that the positions of the coil units may be compact as much as possible, so as to effectively improve a superimposing effect of the charging magnetic fields generated by the coil units to accordingly increase the effective charging distance of a wireless charging device. Moreover, the conductive structure used for serially connecting the coil units is disposed under the first patterned conductive layer instead of being located at a same layer with the coil units, so as to avoid a situation that the conductive structure excessively interferes the charging magnetic fields generated by the coil units.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a side view of an array wireless energy conversion device according to an embodiment of the invention.

FIG. 2 is a top view of a partial structure of the array wireless energy conversion device of FIG. 1.

FIG. 3 is a partial enlarged view of the array wireless energy conversion device of FIG. 2.

FIG. 4 to FIG. 6 are top views of a partial structure of the array wireless energy conversion device of FIG. 1.

FIG. 7A is a magnetic field co-generated by conventional multi-turn coil units.

FIG. 7B is a magnetic field co-generated by the coil units of FIG. 1.

FIG. 7C is a magnetic field co-generated by the coil units of FIG. 1 after gaps of the coil units are increased.

FIG. 8 is a side view of an array wireless energy conversion device according to another embodiment of the invention.

FIG. 9 is a top view of a partial structure of the array wireless energy conversion device of FIG. 8.

FIG. 10 is a top view of a partial structure of an array wireless energy conversion device according to another embodiment of the invention.

FIG. 11 is a flowchart illustrating a design method of an array wireless energy conversion device according to an embodiment of the invention.

FIG. 12A to FIG. 12E illustrate different shapes of the coil units according to other embodiments of the invention.

50: electronic device

100, 200: array wireless energy conversion device

110, 210, 310: first patterned conductive layer

112, 312, 412, 512, 612, 712, 812: coil units

112a: fracture

120, 220: conductive structure

122, 222: second patterned conductive layer

122a, 222a: first conductive sections

124: third patterned conductive layer

124a: second conductive section

124b, 224b: input electrodes

130, 230, 330: dielectric material

C: geometric center

D: distance

E1: first end

E2: second end

E3: third end

L: side

M: permeability magnetic material M

R: radius

S: charging surface

T1: first conductive via

T2: second conductive via

V: direction

### DESCRIPTION OF EMBODIMENTS

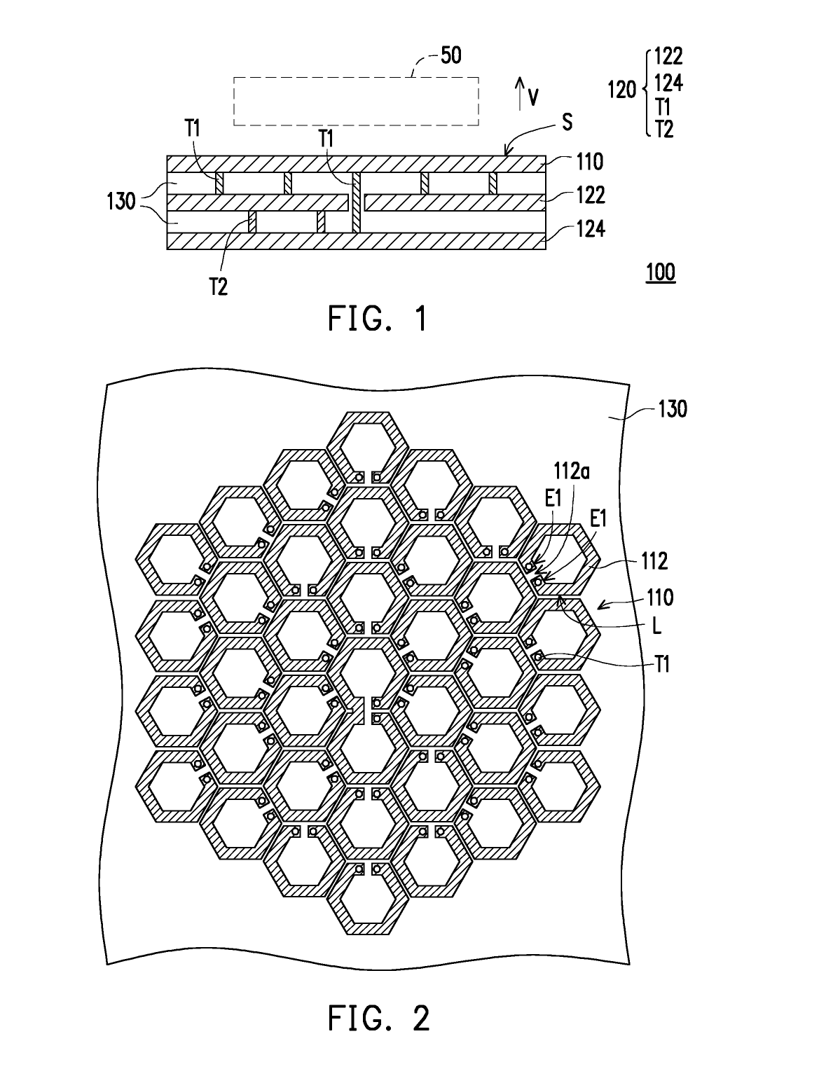

FIG. 1 is a side view of an array wireless energy conversion device according to an embodiment of the invention. FIG. 2 is a top view of a partial structure of the array wireless energy conversion device of FIG. 1, which illustrates a configuration mode of a first patterned conductive layer. Referring to FIG. 1 and FIG. 2, the array wireless energy conversion device 100 of the embodiment includes a first patterned conductive layer 110 and a conductive structure 120. The first patterned conductive layer 110 includes a plurality of coil units 112 with different geometric centers, where the coil units 112 are not structures with the same geometric center, and each of the coil units 112 is located outside each of the other coil units 112. Each of the coil unit 112 is a polygon (which is shown as a regular hexagon), and the coil units 112 are arranged in the most compact manner, and at least one side L (a plurality of sides L are shown) of each of the coil units 112 is adjacent to one side L of another coil unit 112. The coil units 112 may be an appropriate number according to an actual requirement, which is not limited by the invention.

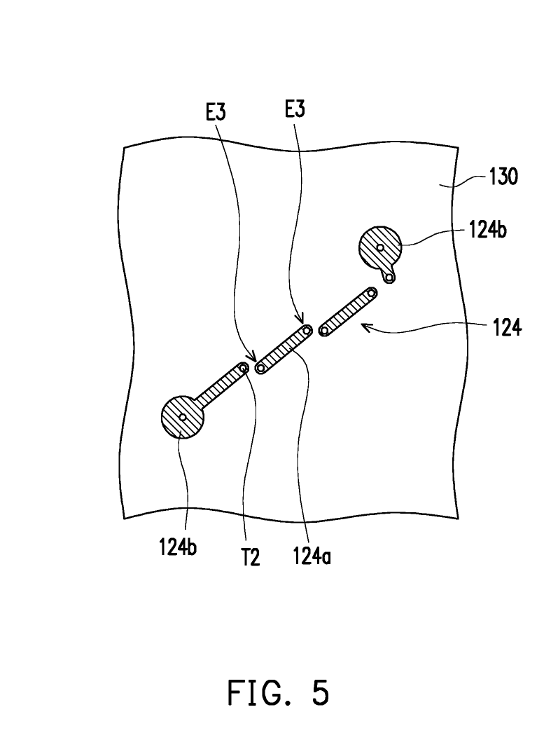

Each of the coil units 112 has a fracture 112a and two first ends E1 corresponding to the fracture 112a. The conductive structure 120 is disposed under the first patterned conductive layer 110 and is connected to the first ends E1, and the coil units 112 construct a continuous circuit through the conductive structure 120. The conductive structure 120 has a pair of input electrodes 124b (shown in FIG. 5), and the input electrodes 124b are adapted to connect an external current. Therefore, the current may sequentially pass through the coil units 112 to form a charging magnetic field in each of the coil units 112, where the current passes through each of the coil units 112 in a clockwise direction or an anticlockwise direction, such that the magnetic fields formed on the coil units and equivalently perpendicular to the first patterned conductive layer have the same polarity direction. A user may put an electronic device 50 above the array wireless energy conversion device 100 to charge the electronic device 50 through the charging magnetic fields.

Under the above configuration, the coil units 112 are distributed in a single layer structure (the first patterned conductive layer 110), instead of sequentially stacking the multi-turn coil units with concentric circles in a direction perpendicular to a charging plane as that does of the conventional coil, and an effective charging distance of the wireless charging device 100 is increased by adjusting an arranging mode of the basic coil units 112 in the array. Further, the arranging mode of the coil units 112 is determined according to a shape (which is, for example, a hexagon) of the coil units 112, and at least one side of each of the coil units 112 is adjacent to one side of another coil unit, such that positions of the coil units 112 are compact as much as possible, so as to effectively improve a superimposing effect of the charging magnetic fields generated by the coil units 112, and accordingly increase the effective charging distance (in the vertical direction V shown in FIG. 1) of the wireless charging device 100. Moreover, the conductive structure 120 used for serially connecting the coil units 112 is disposed under the first patterned conductive layer 110 instead of being located at a same layer with the coil units 112, so as to avoid a situation that the conductive structure 120 excessively interferes the charging magnetic fields generated by the coil units 112.

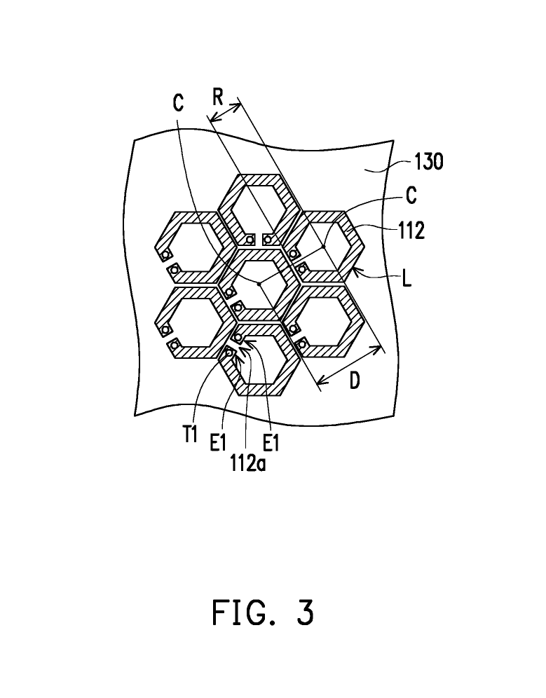

FIG. 3 is a partial enlarged view of the array wireless energy conversion device of FIG. 2. Referring to FIG. 3, to be specific, each of the coil units 112 has a geometric center C and a radius R, where the radius R is the shortest distance between the geometric center C to the side L. As described above, by arranging the coil units 112 in the compact manner as much as possible, a distance D between two geometric centers C of two adjacent coil units 112 is greater than twice of the radius R and smaller than 5/2 of the radius R. In other embodiments, the distance D between two geometric centers C of two adjacent coil units 112 and the radius R may have other proper relationship, which is not limited by the invention.

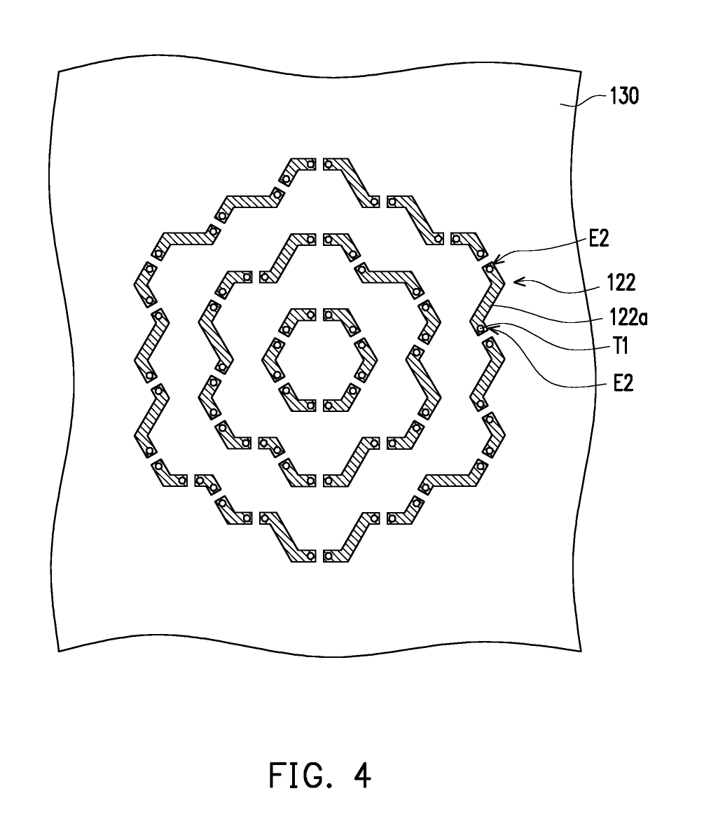

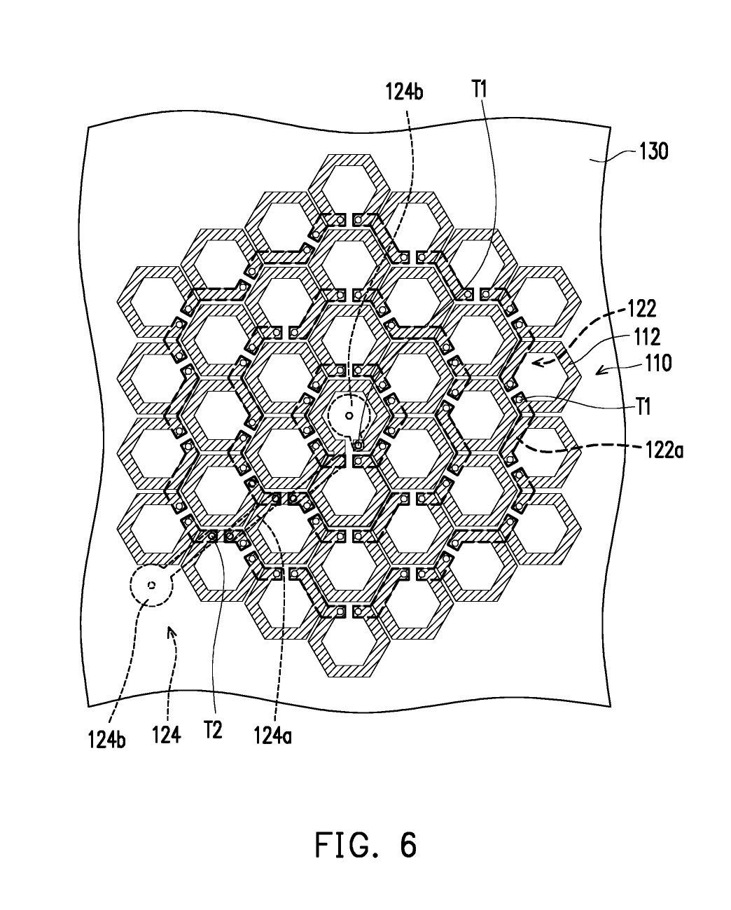

In the embodiment, the first patterned conductive layer 110 and the conductive structure 120 are, for example, formed in a dielectric material 130. Detailed configuration of the conductive structure 120 of the embodiment is described below with reference of FIG. 4 to FIG. 6. FIG. 4 to FIG. 6 are top views of a partial structure of the array wireless energy conversion device of FIG. 1, where FIG. 4 illustrates a configuration of a second patterned conductive layer 122 of the conductive structure 120, FIG. 5 illustrates a configuration of a third patterned conductive layer 124 of the conductive structure 120, and FIG. 6 illustrates relative positions of the first patterned conductive layer 110, the second patterned conductive layer 122 and the third patterned conductive layer 124.

As shown in FIG. 1, FIG. 2 and FIG. 4 to FIG. 6, the conductive structure 120 of the embodiment includes the second patterned conductive layer 122, a plurality of first conductive vias T1, the third patterned conductive layer 124 and a plurality of second conductive vias T2. The second patterned conductive layer 122 includes a plurality of first conductive sections 122a separated from each other, each of the first conductive sections 122a has two second ends E2 opposite to each other, a part of the second ends E2 are respectively aligned with a part of the first ends E1, and a part of the second ends E2 are respectively aligned with a part of the third ends E3. The third patterned conductive layer 124 includes a plurality of second conductive sections 124a separated from each other, and each of the second conductive sections 124a has two third ends E3 opposite to each other. A part of the first ends E1 of the first patterned conductive layer 110 are respectively connected to a part of the second ends E2 of the second patterned conductive layer 122 through a part of the first conductive vias T1, and a part of the first ends E1 are connected to a part of the third ends E3 of the third patterned conductive layer 124 through a part of the first conductive vias T1 (for example, the first conductive via T1 close to the central input electrode 124b shown in FIG. 6). A part of the third ends E3 of the third patterned conductive layer 124 are respectively connected to a part of the second ends E2 of the second patterned conductive layer 122 through a part of the second conductive vias T2. The third patterned conductive layer 124 further includes the input electrodes 124b for inputting a charging current.

As shown in FIG. 6, each of the first conductive sections 122a of the second patterned conductive layer 122 at least partially extends along an extending direction of the coil units 112 of the first patterned conductive layer 110, so as to avoid a situation that the second patterned conductive layer 122 excessively interferes the charging magnetic field generated by the coil units 112. Moreover, the third patterned conductive layer 124 is disposed under the second patterned conductive layer 122 and is located away from the first patterned conductive layer 110, so as to avoid a situation that the third patterned conductive layer 124 excessively interferes the charging magnetic field generated by the coil units 112.

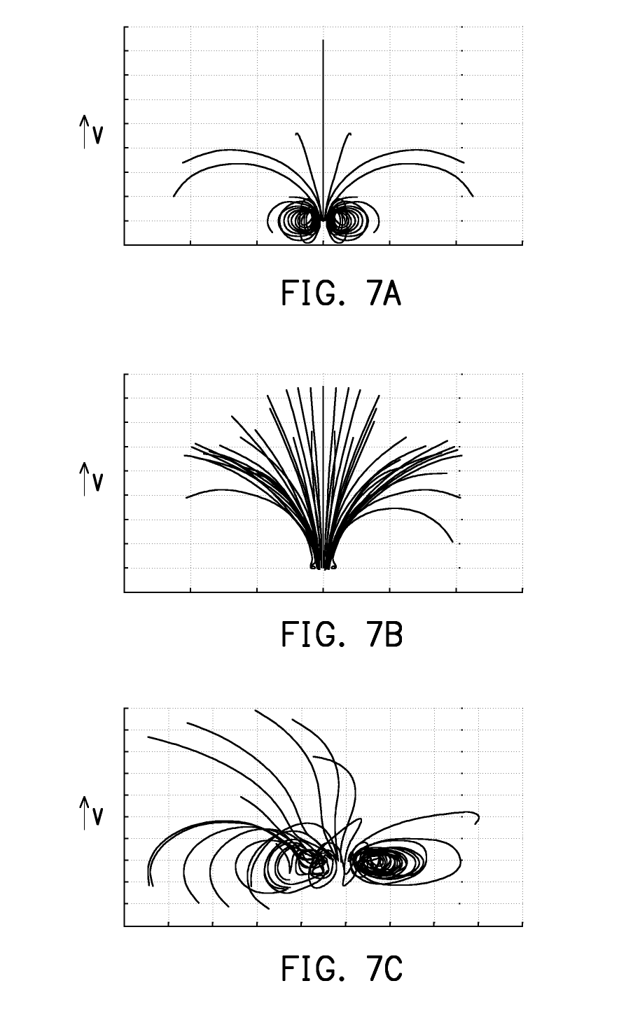

FIG. 7A is a magnetic field co-generated by conventional multi-turn coil units. FIG. 7B is a magnetic field co-generated by the coil units of FIG. 1. FIG. 7C is a magnetic field co-generated by the coil units of FIG. 1 after gaps of the coil units are increased. If there is a thin wire with a steady-state current in vacuum, where the current is a constant I, and the thin wire forms a single closed curve C in space, according to Biot-Savart Law, a magnetic field caused by the current on the whole thin wire at a position P outside the wire is

$$\vec{B} = \frac{{μ}_{0}^{I}}{4 π} \frac{1}{{r}_{rel}^{2}} d {\vec{l}}^{′} \times \hat{u} ,$$

where rᵣₑₗ is a distance between dl′ and P, û is a unit vector of dl′ to P. By performing numerical simulation according to the Biot-Savart Law, a magnetic field co-generated by the conventional multi-turn coil unit as shown in FIG. 7A, a magnetic field co-generated by the coil units 112 of FIG. 1 as shown in FIG. 7B and a magnetic field co-generated by the coil units 112 of FIG. 1 after gaps of the coil units are increased as shown in FIG. 7C are obtained. Compared to the magnetic field (corresponding to FIG. 7A) generated by the single coil unit and the magnetic field (corresponding to FIG. 7C) co-generated by multiple coil units with larger gaps, magnetic lines of force of the magnetic field (corresponding to FIG. 7B) co-generated by the coil units 112 of FIG. 1 are more and are more concentrated in the vertical direction V, which achieves an obvious effect of increasing the effective charging distance in the vertical direction.

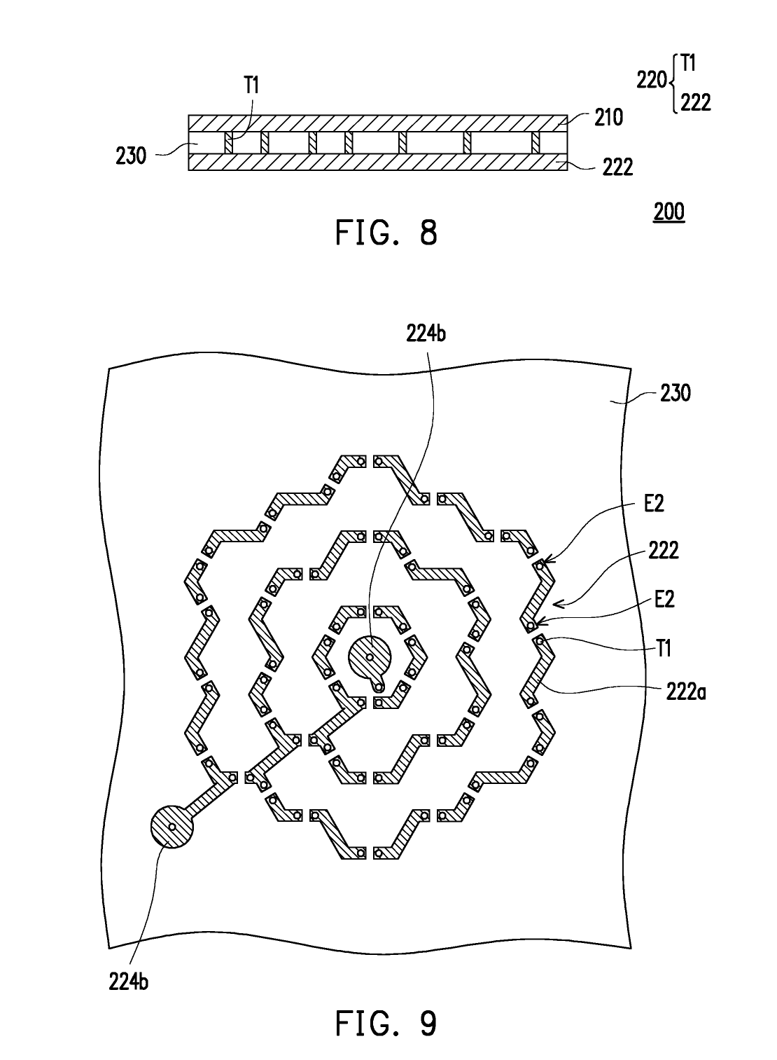

FIG. 8 is a side view of an array wireless energy conversion device according to another embodiment of the invention. FIG. 9 is a top view of a partial structure of the array wireless energy conversion device of FIG. 8, which illustrates a configuration mode of a second patterned conductive layer. In the array wireless energy conversion device 200 of FIG. 8 and FIG. 9, configuration of a first patterned conductive layer 210 and a dielectric material 230 is similar to that of the first patterned conductive layer 110 and the dielectric material 130, and detail thereof is not repeated. A difference between the array wireless energy conversion device 200 and the array wireless energy conversion device 100 is that the array wireless energy conversion device 200 integrates the third patterned conductive layer 124 shown in FIG. 1 and FIG. 5 with the second patterned conductive layer 122 shown in FIG. 4 to form a second patterned conductive layer 222 shown in FIG. 9, and a conductive structure 220 includes the second patterned conductive layer 222 and the first conductive vias T1, the first ends E1 of the first patterned conductive layer 210 are respectively aligned with the second ends E2 of the second patterned conductive layer 222, the first ends E1 of the first patterned conductive layer 210 are respectively connected to the second ends E2 of the second patterned conductive layer 222 through the first conductive vias T1, and the second patterned conductive layer 222 includes a pair of input electrodes 224b. In this way, a manufacturing process of the array wireless energy conversion device 200 is simplified.

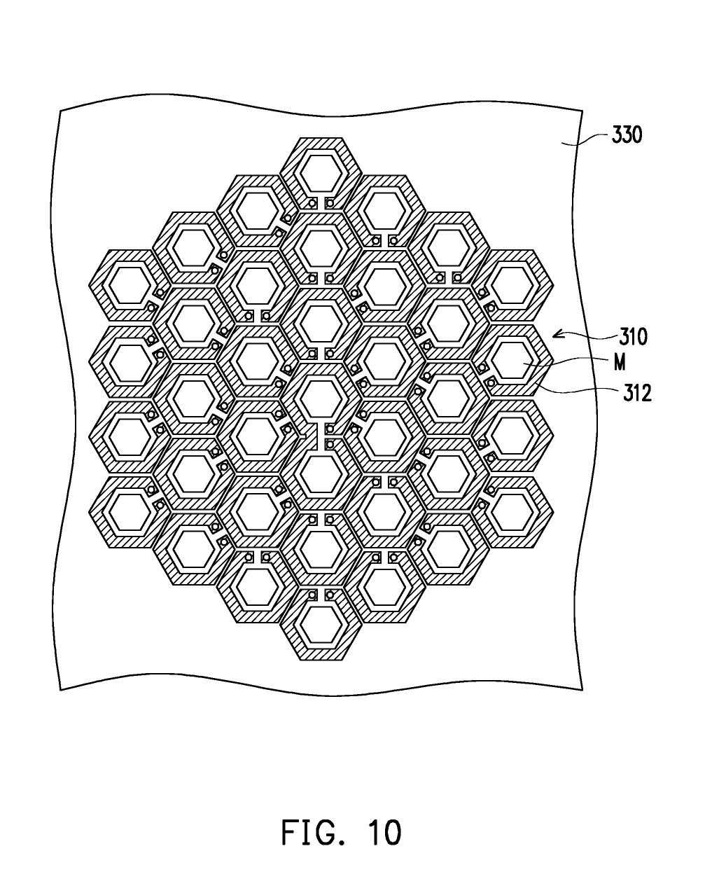

FIG. 10 is a top view of a partial structure of an array wireless energy conversion device according to another embodiment of the invention, which illustrates a configuration mode of the first patterned conductive layer. In the embodiment of FIG. 10, configuration of a first patterned conductive layer 310 and a dielectric material 330 is similar to that of the first patterned conductive layer 110 and the dielectric material 130 of the embodiment of FIG. 2, and detail thereof is not repeated. A difference between the embodiment of FIG. 10 and the embodiment of FIG. 2 is that the array wireless energy conversion device further includes a plurality of permeability magnetic materials M, and the permeability magnetic materials M are respectively configured in the coil units 312 to enhance the magnetic field generated by each of the permeability magnetic materials M.

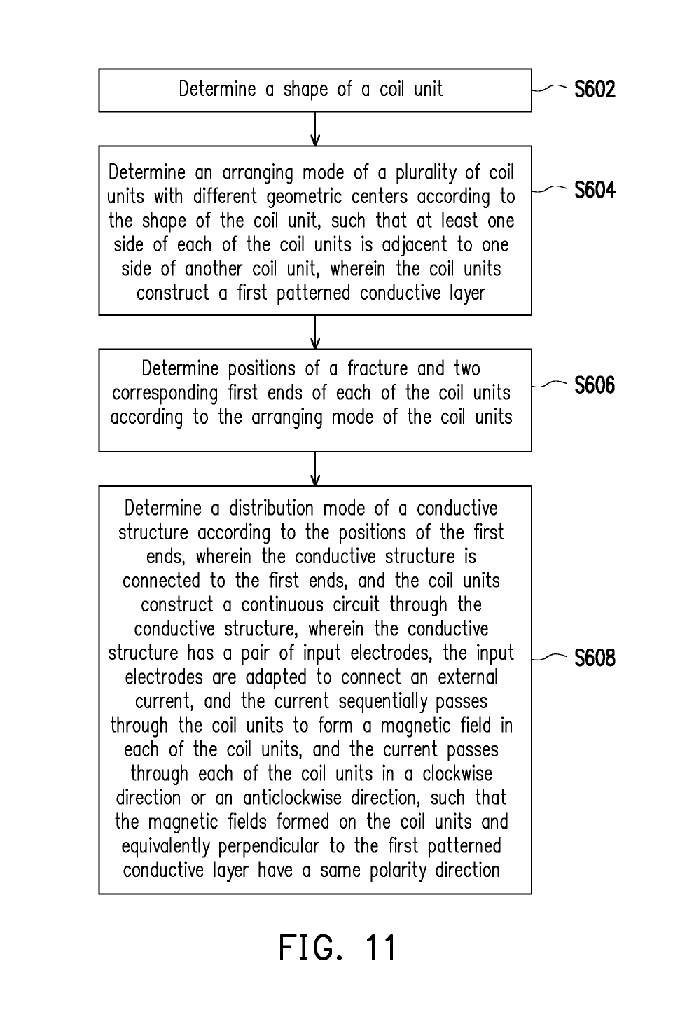

A design method of an array wireless energy conversion device of an embodiment of the invention is described below with reference of figures. FIG. 11 is a flowchart illustrating a design method of an array wireless energy conversion device according to an embodiment of the invention. Referring to FIG. 1, FIG. 2 and FIG. 11, first, a shape of the coil units 112 is determined (step S602). Then, an arranging mode of a plurality of coil units 112 with different geometric centers is determined according to the shape of the coil units 112, such that at least one side L of each of the coil units 112 is adjacent to one side L of another coil unit 112, where the coil units 112 construct the first patterned conductive layer 110 (step S604). Positions of the fracture 112a and the two corresponding first ends E1 of each of the coil units 112 are determined according to the arranging mode of the coil units 112 (step S606). A distribution mode of the conductive structure 120 is determined according to the positions of the first ends E1, where the conductive structure 120 is connected to the first ends E1, and the coil units 112 construct a continuous circuit through the conductive structure 120, where the conductive structure 120 has a pair of input electrodes 124b, the input electrodes 124b are adapted to connect an external current, and the current sequentially passes through the coil units 112 to form a magnetic field in each of the coil units 112, and the current passes through each of the coil units 112 in a clockwise direction or an anticlockwise direction, such that the magnetic fields formed on the coil units 112 and equivalently perpendicular to the first patterned conductive layer 110 have the same polarity direction (step S608).

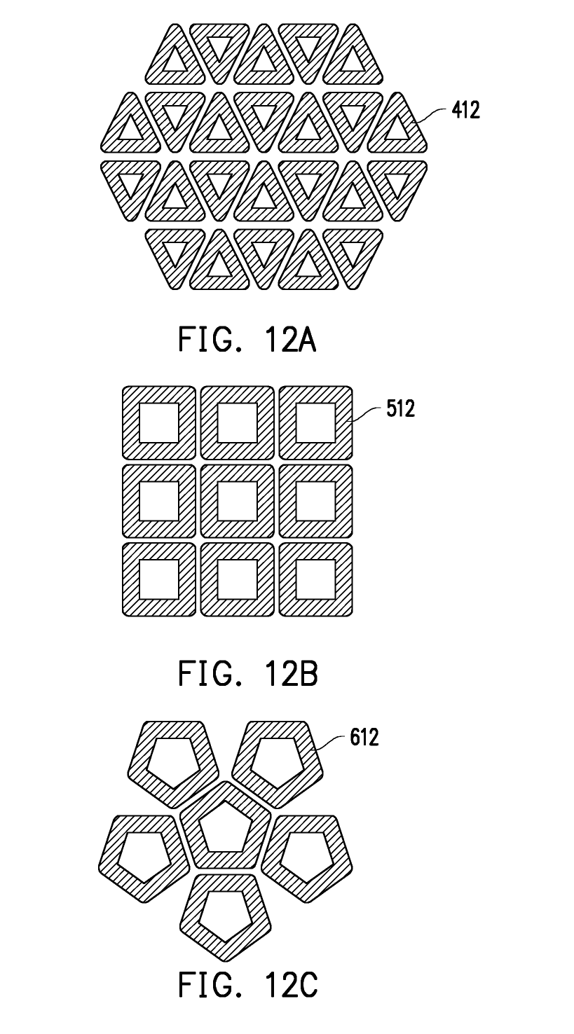

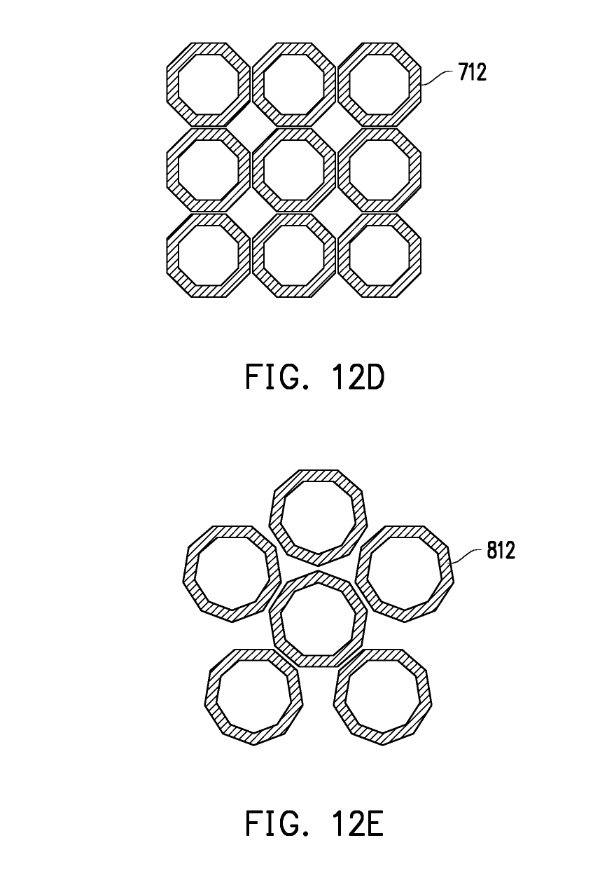

In the above step S602, besides that the shape of the coil units 112 is determined as the hexagon shown in FIG. 2, it may also be determined as other shapes, which is described below. FIG. 12A to FIG. 12E illustrate different shapes of the coil units according to other embodiments of the invention, in which the coil units without fractures are illustrated. In the embodiments of FIG. 12A to FIG. 12E, the shapes of the coil units 412, 512, 612, 712 and 812 are respectively determined as triangles, quadrilaterals, pentagons, octagons, nonagons, and the coil units are arranged in the compact manner as much as possible.

Referring to FIG. 2, FIG. 8 and FIG. 9, in the above step S608, the step of determining the distribution mode of the conductive structure 220 includes: determining a distribution mode of the second patterned conductive layer 222 and a plurality of the first conductive vias T1 according to the positions of the first ends E1, where the first ends E1 are respectively connected to the second patterned conductive layer 222 through the first conductive vias T1, and the second patterned conductive layer 222 includes the input electrodes 224b.

The step of determining the distribution mode of the second patterned conductive layer 222 includes: determining positions of a plurality of first conductive sections 222a separated from each other according to the positions of the first ends E1, where each of the first conductive sections 222a has two second ends E2 opposite to each other, and the second ends E2 are respectively aligned with the first ends E1, and are respectively connected to the first ends E1 through the first conductive vias T1.

Referring to FIG. 1, FIG. 2, FIG. 4, FIG. 5 and FIG. 6, in the above step S608, the step of determining the distribution mode of the conductive structure 120 includes: determining a distribution mode of a part of the second patterned conductive layer 122, a part of the third patterned conductive layer 124 and a plurality of the first conductive vias T1 according to the positions of the first ends E1, where a part of the first ends E1 are respectively connected to a part of the second patterned conductive layer 122 through a part of the first conductive vias T1, and a part of the first ends E1 are connected to a part of the third patterned conductive layer 124 through a part of the first conductive vias T1 (for example, the first conductive via T1 close to the central input electrode 124b shown in FIG. 6). Moreover, in the above step S608, the step of determining the distribution mode of the conductive structure 120 further includes: determining a distribution mode of a part of the third patterned conductive layer 124 and a plurality of the second conductive vias T2 according to the distribution mode of a part of the second patterned conductive layer 122, where a part of the third patterned conductive layer 124 is connected to a part of the second patterned conductive layer 122 through the second conductive vias T2, and the third patterned conductive layer 124 includes the input electrodes 124b.

The step of determining the distribution mode of the second patterned conductive layer 122 includes: determining positions of a plurality of the first conductive sections 122a separated from each other according to the positions of a part of the first ends E1 and positions of the second conductive vias T2, where each of the first conductive sections 122a has two second ends E2 opposite to each other, and a part of the second ends E2 are respectively aligned with a part of the first ends E1, and are respectively connected to a part of the first ends E1 through a part of the first conductive vias T1. A part of the second ends E2 are respectively aligned with the second conductive vias T2 to connect a part of the third patterned conductive layer 124.

The step of determining the positions of the first conductive sections 122a includes determining an extending direction of each of the first conductive sections 122a according to an extending direction of the coil units 112, where each of the first conductive sections 122a at least partially extends along the extending direction of the coil units 112.

The step of determining the distribution mode of the third patterned conductive layer 124 includes: determining positions of a plurality of the second conductive sections 124a separated from each other according to the distribution mode of a part of the second patterned conductive layer 122 and the distribution mode of a part of the first patterned conductive layer 110, where each of the second conductive sections 124a has two third ends E3 opposite to each other, a part of the third ends E3 are connected to a part of the second patterned conductive layer 122 through the second conductive vias T2, and a part of the third ends E3 are connected to the first patterned conductive layer 110 through a part of the first conductive vias T1 (for example, the first conductive via T1 close to the central input electrode 124b shown in FIG. 6).

Referring to FIG. 10, the design method of the array wireless energy conversion device may further include a following step: determining positions of a plurality of the permeability magnetic materials M according to the positions of the coil units 312, where the permeability magnetic materials M are respectively configured in the coil units 312.

In summary, in the array wireless energy conversion device of the invention, the coil units are distributed in a single-layer structure (the first patterned conductive layer) in different geometric centers, instead of sequential stacking the multi-turn coil units with concentric circles as that does of the conventional coils. Therefore, through a proper arrangement and distribution of the coil units, the charging magnetic fields generated by the coil units are sufficiently superimposed in the direction perpendicular to the first patterned conductive layer to increase a distribution altitude of the charging magnetic fields. Further, by determining the arranging mode of the coil units according to the shape of the coil units, at least one side of each coil unit is adjacent to one side of another coil unit, such that the positions of the coil units may be compact as much as possible, so as to effectively improve a superimposing effect of the charging magnetic fields generated by the coil units to accordingly increase the effective charging distance of the wireless charging device. Moreover, the conductive structure used for serially connecting the coil units is disposed under the first patterned conductive layer instead of being located at a same layer with the coil units, so as to avoid a situation that the conductive structure excessively interferes the charging magnetic fields generated by the coil units.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An array wireless energy conversion device, comprising:
a first patterned conductive layer, comprising a plurality of coil units with different geometric centers, wherein each of the coil units is a polygon, at least one side of each of the coil units is adjacent to one side of another of the coil units, and each of the coil units has a fracture and two first ends corresponding to the fracture; and
a conductive structure, disposed under the first patterned conductive layer and connected to the first ends, such that the coil units construct a continuous circuit through the conductive structure, wherein the conductive structure has a pair of input electrodes, the pair of input electrodes are adapted to connect an external current, so that the current sequentially passes through the coil units to form a magnetic field in each of the coil units, wherein the current passes through each of the coil units in a clockwise direction or an anticlockwise direction, such that the magnetic fields formed on the coil units and equivalently perpendicular to the first patterned conductive layer have a same polarity direction.

2. The array wireless energy conversion device as claimed in claim 1, wherein the conductive structure comprises a second patterned conductive layer and a plurality of first conductive vias, the first ends are respectively connected to the second patterned conductive layer through the first conductive vias, wherein the second patterned conductive layer comprises the pair of input electrodes.

3. The array wireless energy conversion device as claimed in claim 2, wherein the second patterned conductive layer comprises a plurality of first conductive sections separated from each other, each of the first conductive sections has two second ends opposite to each other, and the second ends are respectively aligned with the first ends and are respectively connected to the first ends through the first conductive vias.

4. The array wireless energy conversion device as claimed in claim 1, wherein the conductive structure comprises a second patterned conductive layer, a plurality of first conductive vias, a third patterned conductive layer and a plurality of second conductive vias, a part of the first ends are respectively connected to a part of the second patterned conductive layer through a part of the first conductive vias, a part of the first ends are connected to a part of the third patterned conductive layer through a part of the first conductive vias, and a part of the third patterned conductive layer is connected to a part of the second patterned conductive layer through the second conductive vias, and the third patterned conductive layer comprises the pair of input electrodes.

5. The array wireless energy conversion device as claimed in claim 4, wherein the second patterned conductive layer comprises a plurality of first conductive sections separated from each other, each of the first conductive sections has two second ends opposite to each other, the third patterned conductive layer comprises a plurality of second conductive sections separated from each other, each of the second conductive sections has two third ends opposite to each other, a part of the second ends are respectively aligned with a part of the first ends and are respectively connected to a part of the first ends through a part of the first conductive vias, a part of the second ends are respectively aligned with a part of the third ends and are respectively connected to a part of the third ends through the second conductive vias, a part of the third ends are respectively connected to a part of the second patterned conductive layer through the second conductive vias, and a part of the third ends are connected to a part of the first patterned conductive layer through a part of the first conductive vias.

6. The array wireless energy conversion device as claimed in claim 1, further comprising a plurality of permeability magnetic materials, wherein the permeability magnetic materials are respectively configured in the coil units.

7. The array wireless energy conversion device as claimed in claim 1, wherein each of the coil units has a geometric center and a radius, the radius is the shortest distance between the geometric center and the side, and a distance between two of the geometric centers of two adjacent ones of the coil units is greater than twice of the radius and smaller than 5/2 of the radius.

8. The array wireless energy conversion device as claimed in claim 1, wherein the geometric center of each of the coil units is located outside each of the other coil units.

9. A design method of an array wireless energy conversion device, comprising:
determining a shape of a coil unit;
determining an arranging mode of a plurality of coil units with different geometric centers according to the shape of the coil unit, such that at least one side of each of the coil units is adjacent to one side of another of the coil units, wherein the coil units construct a first patterned conductive layer;
determining positions of a fracture and two corresponding first ends of each of the coil units according to the arranging mode of the coil units; and
determining a distribution mode of a conductive structure according to the positions of the first ends, wherein the conductive structure is connected to the first ends, such that the coil units construct a continuous circuit through the conductive structure, wherein the conductive structure has a pair of input electrodes, the pair of input electrodes are adapted to connect an external current, so that the current sequentially passes through the coil units to form a magnetic field in each of the coil units, wherein the current passes through each of the coil units in a clockwise direction or an anticlockwise direction, such that the magnetic fields formed on the coil units and equivalently perpendicular to the first patterned conductive layer have a same polarity direction.

10. The design method of the array wireless energy conversion device as claimed in claim 9, wherein the step of determining the distribution mode of the conductive structure comprises:
determining a distribution mode of a second patterned conductive layer and a plurality of first conductive vias according to the positions of the first ends, wherein the first ends are respectively connected to the second patterned conductive layer through the first conductive vias, and the second patterned conductive layer comprises the pair of input electrodes.

11. The design method of the array wireless energy conversion device as claimed in claim 10, wherein the step of determining the distribution mode of the second patterned conductive layer comprises:
determining positions of a plurality of first conductive sections separated from each other according to the positions of the first ends, wherein each of the first conductive sections has two second ends opposite to each other, and the second ends are respectively aligned with the first ends, and are respectively connected to the first ends through the first conductive vias.

12. The design method of the array wireless energy conversion device as claimed in claim 9, wherein the step of determining the distribution mode of the conductive structure comprises:
determining a distribution mode of a part of a second patterned conductive layer, a part of a third patterned conductive layer and a plurality of first conductive vias according to the positions of the first ends, wherein a part of the first ends are respectively connected to a part of the second patterned conductive layer through a part of the first conductive vias, and a part of the first ends are connected to a part of the third patterned conductive layer through a part of the first conductive vias; and
determining a distribution mode of a part of the third patterned conductive layer and a plurality of second conductive vias according to the distribution mode of a part of the second patterned conductive layer, wherein a part of the third patterned conductive layer is connected to a part of the second patterned conductive layer through the second conductive vias, and the third patterned conductive layer comprises the pair of input electrodes.

13. The design method of the array wireless energy conversion device as claimed in claim 12, wherein the step of determining the distribution mode of the second patterned conductive layer comprises:
determining positions of a plurality of first conductive sections separated from each other according to the positions of a part of the first ends and positions of the second conductive vias, wherein each of the first conductive sections has two second ends opposite to each other, a part of the second ends are respectively aligned with a part of the first ends, and are respectively connected to a part of the first ends through a part of the first conductive vias, and a part of the second ends are respectively aligned with the second conductive vias to connect a part of the third patterned conductive layer,
wherein the step of determining the distribution mode of the third patterned conductive layer comprises:
determining positions of a plurality of second conductive sections separated from each other according to the distribution mode of a part of the second patterned conductive layer and the distribution mode of a part of the first patterned conductive layer, wherein each of the second conductive sections has two third ends opposite to each other, a part of the third ends are respectively connected to a part of the second patterned conductive layer through the second conductive vias, and a part of the third ends are connected to the first patterned conductive layer through a part of the first conductive vias.
